(19) United States
(12) Patent Application Publication
(10) Pub. No.: US 2025/0017265 A1
(43) Pub. Date: Jan. 16, 2025

(54) HYBRID AEROSOL-GENERATING SYSTEM WITH MODULAR CONSUMABLE

(71) Applicant: PHILIP MORRIS PRODUCTS S.A., Neuchatel (CH)

(72) Inventors: Rui Nuno Rodrigues Alves Batista, Morges (CH); Ricardo Cali, Mannheim (DE); Cheng Peng, Neuchatel (CH); Yiu Chi Cheung, Hong Kong (CN)

(21) Appl. No.: 18/715,399

(22) PCT Filed: Dec. 5, 2022
(86) PCT No.: PCT/EP2022/084428

§ 371 Date: May 31, 2024

(30) Foreign Application Priority Data
Dec. 7, 2021 (EP) 21212821.9

(51) Int. Cl. A24F 40/30; A24D 1/20; A24F 40/10; A24F 40/20; A24F 40/46; A24F 40/465

(52) U.S. Cl. CPC A24F 40/30; A24D 1/20; A24F 40/10; A24F 40/20; A24F 40/46; A24F 40/465

(57) ABSTRACT

The invention relates to an aerosol-generating system comprising an aerosol-generating device (16) and a consumable (10) for the aerosol-generating device. The aerosol-generating device may comprise a cavity (18) for receiving the consumable and a first heating element (20, 22) arranged to at least partly heat the consumable when the consumable is received in the cavity. The aerosol-generating device may further comprise an airflow channel (14). The airflow channel may be arranged to direct air through the device and into the cavity. The consumable may comprise a tubular wall (12). The tubular wall may extend from a distal opening of the consumable to an opposite proximal opening of the consumable. The consumable may be arranged, when the consumable is received in the cavity, such that the air flowing into the cavity from the airflow channel flows into the distal opening of the consumable.

The present invention relates to an aerosol-generating system.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of a consumable such as an aerosol-generating article. The aerosol-generating article may have a rod shape for insertion of the aerosol-generating article into a cavity, such as a heating chamber, of the aerosol-generating device. A heating element may be arranged in or around the heating chamber for heating the aerosol-forming substrate once the aerosol-generating article is inserted into the heating chamber of the aerosol-generating device. To additionally enable delivery of nicotine or for influencing the flavor of the generated aerosol or for improving the aerosol quality, the aerosol-generating device may comprise a liquid storage portion upstream of the heating chamber. The liquid storage portion may comprise a liquid aerosol-forming substrate. The liquid aerosol-forming substrate may contain one or more of nicotine and a flavourant. In this conventional aerosol-forming systems comprising the aerosol-generating device and the consumable, use may be limited to the case that the consumable is received in the heating chamber.

It would be desirable to have an aerosol-generating system with increased flexibility for using the system. It would be desirable to have an aerosol-generating system that is usable without the dedicated consumable. It would be desirable to have an aerosol-generating system with flexibility of enhancing or changing the flavor of the generated aerosol.

According to an embodiment of the invention there is provided an aerosol-generating system comprising an aerosol-generating device and a consumable for the aerosol-generating device. The aerosol-generating device may comprise a cavity for receiving the consumable and a first heating element arranged to at least partly heat the consumable when the consumable is received in the cavity. The aerosol-generating device may further comprise an airflow channel. The airflow channel may be arranged to direct air through the device and into the cavity. The consumable may comprise a tubular wall. The tubular wall may extend from a distal opening of the consumable to an opposite proximal opening of the consumable. The consumable may be arranged, when the consumable is received in the cavity, such that the air flowing into the cavity from the airflow channel flows into the distal opening of the consumable.

According to an embodiment of the invention there is provided an aerosol-generating system comprising an aerosol-generating device and a consumable for the aerosol-generating device. The aerosol-generating device comprises a cavity for receiving the consumable and a first heating element arranged to at least partly heat the consumable when the consumable is received in the cavity. The aerosol-generating device further comprises an airflow channel. The airflow channel is arranged to direct air through the device and into the cavity. The consumable comprises a tubular wall. The tubular wall extends from a distal opening of the consumable to an opposite proximal opening of the consumable. The consumable is arranged, when the consumable is received in the cavity, such that the air flowing into the cavity from the airflow channel flows into the distal opening of the consumable.

Providing a consumable with a tubular wall extending over the full length of the consumable leads to a consumable through which air can flow unimpeded.

The tubular wall may preferably be a tubular cellulose-based wall.

Providing the tubular wall as a tubular cellulose-based wall leads to an easy to manufacture consumable. Providing the tubular wall as a tubular cellulose-based wall leads to a low cost consumable.

The tubular wall may be a tubular metallized paper wall. The tubular wall may be a tubular metal-paper laminate wall.

The tubular wall may have a thickness of between 3 mm and 7 mm, preferably between 4 mm and 6 mm, more preferably between 3.5 mm and 5.75 mm.

The tubular wall with such a thickness may provide dimensional stability to the consumable.

The tubular wall may have a porosity such as to prevent formation of moisture inside of the consumable. The tubular wall may have a porosity such as to prevent condensation of moisture inside of the consumable. The first heating element may heat one or both of moisture and condensation absorbed by the tubular wall to prevent a build-up of one or both the moisture and the condensation.

The tubular wall may have a porosity such that vapor may escape through the tubular wall to create a pleasant flavor of the consumable during operation of the aerosol-generating device.

The tubular shape of the tubular wall may form a consumable airflow channel. The consumable airflow channel may be arranged centrally through the consumable. The consumable airflow channel may be circumscribed by the tubular wall. The consumable airflow channel may be straight. The consumable airflow channel may have a diameter of between 2.5 mm and 8.75 mm, more preferably between 3 mm and 7 mm.

The consumable may have an outer diameter of between 4.1 mm to 9 mm, preferably between 4.5 mm to 7.7 mm. The consumable may have a length of between 34 mm to 108 mm, preferably between 50 mm and 70 mm.

The aerosol-generating device may further comprise a liquid storage portion containing liquid aerosol-forming substrate.

The aerosol-generating device may be configured as a hybrid device. The liquid storage portion containing the liquid aerosol-forming substrate may be configured to generate an inhalable aerosol. The consumable received in the cavity may be configured to provide flavor to the generated aerosol.

The aerosol generated via the liquid aerosol-forming substrate of the liquid storage portion may be generated by the aerosol-generating device upstream of the cavity. The generated aerosol may flow into the cavity and into the consumable airflow channel of the consumable. In the consumable airflow channel, flavor may be added to the aerosol via the consumable. Subsequently, the aerosol with the chosen flavor may flow out of the proximal opening of the consumable and into the mouth of the user.

Different types of consumables may be received in the cavity. As a consequence, a user may choose a flavor by choosing a different type of consumable. In this way, the aerosol generation of the aerosol-generating device can be customized. While the aerosol itself may always be generated via the liquid aerosol-forming substrate of the liquid storage portion, the flavor of the aerosol may be changed according to the type of consumable received in the cavity.

The aerosol-generating device may further comprise a second heating element configured to volatilize the liquid aerosol-forming substrate.

The second heating element may heat the liquid aerosol-forming substrate. The second heating element may have the function of creating the aerosol upstream of the cavity.

The volatilized liquid aerosol-forming substrate may cool down during the flow of the volatilized liquid aerosol-forming substrate through the consumable airflow channel. Small droplets may form during cooling of the volatilized liquid aerosol-forming substrate thereby generating an improved inhalable aerosol.

The second heating element may be arranged to volatilize the liquid aerosol-forming substrate upstream of the cavity.

This may have the advantage that the heated volatilized liquid aerosol-forming substrate can cool down during flowing through the consumable airflow channel. When the final aerosol reaches the mouth of the user, the droplet size of the generated aerosol as well as the temperature of the generated aerosol may be optimal for inhalation.

The aerosol-generating device may further comprise an air inlet. The air inlet may be arranged distal from the cavity and proximal from the liquid storage portion.

The air inlet may be arranged in a housing of the aerosol-generating device. The air inlet may be a lateral air inlet. Ambient air may be drawn into the aerosol-generating device via the air inlet. The ambient air may be drawn laterally into the aerosol-generating device.

The air inlet may be fluidly connected with a device airflow channel. The device airflow channel may be configured for directing the ambient air one or more of against and over and around the second heating element.

The ambient air may thus be entrained with volatilized aerosol-forming substrate that is heated by the second heating element. The device airflow channel may further be configured to direct the mixture of ambient air and volatilized aerosol-forming substrate towards the cavity in which the consumable is received. The mixture of volatilized aerosol-forming substrate and ambient air may be directed, via the device airflow channel, into the consumable airflow channel.

The second heating element may be a resistive heating element.

The aerosol-generating device may further comprise a wick extending into the liquid storage portion. The second heating element may be a heating coil arranged around the wick. The first heating element may be an inductive heating element.

The first heating element may be configured to be heated to a temperature of between 190° C. and 280° C., more preferably to a temperature of between 210° C. and 270° C.

The first heating element may comprise an induction coil and a tubular susceptor. The tubular susceptor may be arranged surrounding a distal portion of the cavity.

The first heating element may be arranged to heat a distal portion of the consumable, when the consumable is received in the cavity. Heating of the distal portion of the consumable may release a flavorant of the consumable. The released flavorant may add flavor to the aerosol being drawn through the consumable airflow channel.

The consumable may comprise a layer of sensorial media on one or both of the inner surface of the tubular wall and the outer surface of the tubular wall.

The sensorial media may be a flavourant. The sensorial media may a flavoring compound. The sensorial media may provided as a gel. The gel may have adequate fluidity to be applied in spray coating or similar standard manufacturing process. The sensorial media may include 0.1-80 wt. % of menthol, 1-60 wt. % of a gelling agent and 0.1-50 wt. % of an aerosol-former. The gelling agent may comprise alginate and pectin. A ratio between alginate and pectin may be between 3:1 and 10:1. The gelling agent may comprise a calcium-crosslinked alginate which may comprise a-(1-4)-linked L-guluronate (G) units. The aerosol-former may comprise highly volatile material. The aerosol-former may comprise one or more of: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate, and typical propylene glycol (PG) and vegetable glycerin (VG) as base carriers for aerosol materials, as well as water-based aerosol-former as a primary carrier. Water which may be used to replace the former aerosol-former materials, since the heat for volatilization of the water content may be sufficient during operation of the device. Water-based carriers may thus be used as a sustainable solution. Alternatively, as sensorial media, wax containing flavoring molecules may be employed as a coating layer with a thickness of about 0.03 to 0.7 mm. Due to the nature of the cellulose-based wall, a certain amount of the coating material will be naturally impregnated or applied onto the fibrous substrate. Between 7% to 41%, preferably between 11% to 38% of inner surface of the cellulose-based wall may be impregnated with the sensorial media. The inner surface of the cellulose-based wall is preferably porous.

The tubular wall may be made of at least one internal layer of cellulose-based, paper-based, foil. Alternatively, the tubular wall may comprise one or more of cellulose acetate tow and other fiber-based materials, preferably high retention and release materials.

The sensorial media may be coated onto or impregnated into one or both of the inner surface of the tubular wall and the outer surface of the tubular wall.

The sensorial media may be configured to be released, when the sensorial media is heated. The sensorial media may be heated via the first heating element. The sensorial media may be heated by the heated volatilized liquid aerosol-forming substrate flowing through the consumable and thus flowing past the sensorial media.

The sensorial media may be arranged in the distal portion of the consumable that is surrounded by the first heating element, when the consumable is received in the cavity.

Alternatively, the sensorial media may be arranged over the full length of the consumable. In other words, the sensorial media may be arranged from the proximal opening of the consumable to the distal opening of the consumable. The sensorial media may at least partially, preferably fully, cover the inner surface of the tubular wall.

The sensorial media may be configured as a sensorial media layer or sensorial media film.

The consumable may comprise a tipping paper surrounding the tubular wall. The tipping paper may be made of a paper-based material.

The consumable may consist of the tubular wall and a layer of sensorial media on the inner surface of the tubular wall or the consumable may consist of the tubular wall and a layer of sensorial media on the inner surface of the tubular wall and a tipping paper surrounding the tubular wall. In other words, the consumable may not comprise any other elements except for the tubular wall and the sensorial media or the consumable may not comprise any other elements except for the tubular wall, the sensorial media and the tipping paper.

Providing such a simple consumable may lead to lower manufacturing costs of the consumable. At the same time, a complex aerosol may be generated by the combination of the simple consumable with the generation of the aerosol in the device by means of the volatilization of the liquid aerosol-forming substrate of the liquid storage portion by means of the second heating element.

In such a hybrid device, the consumable may have the function of adding flavor to the aerosol. Additionally or alternatively, the consumable may have the function of providing a cooling channel for the volatilized aerosol-forming substrate to generate the inhalable aerosol.

The consumable may be free of tobacco.

The cavity may be dimensioned to receive the consumable as described herein or a consumable comprising tobacco having a larger diameter.

This embodiment further improves the flexibility of the aerosol-generating system. In addition to a simple tobacco free consumable as described herein, a more complex consumable comprising tobacco may alternatively be received in the cavity.

The invention further relates to a consumable for an aerosol-generating device, wherein the consumable comprises any of the consumable features described herein.

Particularly, the consumable may comprise a tubular wall as described herein, preferably extending from the distal opening of the consumable to the opposite proximal opening of the consumable.

Particularly, air may flow into the distal opening of the consumable and through the consumable and out of the proximal opening of the consumable as described herein.

Particularly, the consumable may comprise a layer of sensorial media on one or both of the inner surface of the tubular wall and the outer surface of the tubular wall as described herein.

Particularly, the sensorial media may be a flavourant that is coated onto or applied to or impregnated into one or both of the inner surface of the tubular wall and the outer surface of the tubular wall as described herein.

Particularly, the consumable may comprise a tipping paper surrounding the tubular wall as described herein.

Particularly, the consumable may consist of the tubular wall and a layer of sensorial media on the inner surface of the tubular wall or the consumable may consist of the tubular wall and a layer of sensorial media on the inner surface of the tubular wall and a tipping paper surrounding the tubular wall as described herein.

Particularly, the consumable may be free of tobacco as described herein.

The cavity of the aerosol-generating device may have an open end into which the consumable is inserted. The open end may be a proximal end. The cavity may have a closed end opposite the open end. The closed end may be the base of the cavity. The closed end may be closed except for the provision of air apertures arranged in the base. The air apertures may be fluidly connected with the device airflow channel. Alternatively, the device airflow channel may directly lead into the cavity via a single aperture. The base of the cavity may be flat. The base of the cavity may be circular. The base of the cavity may be arranged upstream of the cavity. The open end may be arranged downstream of the cavity. The cavity may have an elongate extension. The cavity may have a longitudinal central axis. A longitudinal direction may be the direction extending between the open and closed ends along the longitudinal central axis. The longitudinal central axis of the cavity may be parallel or along to the longitudinal axis of the aerosol-generating device.

The cavity may be configured as a heating chamber. The cavity may have a cylindrical shape. The cavity may have a hollow cylindrical shape. The cavity may have a shape corresponding to the shape of the consumable to be received in the cavity. The cavity may have a circular cross-section. The cavity may have an elliptical or rectangular cross-section. The cavity may have an inner diameter corresponding to the outer diameter of the consumable.

The capillary material arranged for wicking the liquid aerosol-forming substrate in the liquid storage portion to the second heating element may have a fibrous or spongy structure. The capillary material preferably comprises a bundle of capillaries. For example, the capillary material may comprise a plurality of fibres or threads or other fine bore tubes. The fibres or threads may be generally aligned to convey liquid to the second heating element. Alternatively, the capillary material may comprise sponge-like or foam-like material. The structure of the capillary material forms a plurality of small bores or tubes, through which the liquid can be transported by capillary action. The capillary material may comprise any suitable material or combination of materials. Examples of suitable materials are a sponge or foam material, ceramic- or graphite-based materials in the form of fibres or sintered powders, foamed metal or plastics materials, a fibrous material, for example made of spun or extruded fibres, such as cellulose acetate, polyester, or bonded polyolefin, polyethylene, ethylene or polypropylene fibres, nylon fibres or ceramic. The capillary material may have any suitable capillarity and porosity so as to be used with different liquid physical properties. The liquid has physical properties, including but not limited to viscosity, surface tension, density, thermal conductivity, boiling point and vapour pressure, which allow the liquid to be transported through the capillary material by capillary action. The capillary material may be configured to convey the aerosol-forming substrate to the second heating element. The capillary material may extend into interstices in the second heating element. Preferably, as described herein, the second heating element is configured as a resistive heating coil surrounding the capillary material.

The capillary material may be arranged to contact liquid held in the liquid storage portion. The capillary material may extend into the liquid storage portion. In this case, in use, liquid may be transferred from the liquid storage portion to the second heating element by capillary action. The capillary material may have a first end and a second end. The first end may extend into the liquid storage portion to draw liquid aerosol-forming substrate held in the liquid storage portion to the second heating element. The second end of the capillary material may be surrounded by the second heating element.

The aerosol-generating device may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to one or both of the first heating element and the second heating element. Power may be supplied to one or both of the first heating element and the second heating element continuously following activation of the aerosol-generating device or may be supplied intermittently, such as on a puff-by-puff basis. The power may be supplied to one or both of the first heating element and the second heating element in the form of pulses of electrical current. The electric circuitry may be configured to monitor the electrical resistance of one or both of the first heating element and the second heating element, and preferably to control the supply of power to one or both of the first heating element and the second heating element dependent on the electrical resistance of one or both of the first heating element and the second heating element.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of one or both of the first heating element and the second heating element.

A wall of the housing of the aerosol-generating device may be provided with the at least one air inlet. The air inlet may be a semi-open inlet. The semi-open inlet may be an inlet which permits air or fluid flow in one direction, such as into the device, but at least restricts, preferably prohibits, air or fluid flow in the opposite direction. The semi-open inlet preferably allows air to enter the aerosol-generating device. Air or liquid may be prevented from leaving the aerosol-generating device through the semi-open inlet. The semi-open inlet may for example be a semi-permeable membrane, permeable in one direction only for air, but is air- and liquid-tight in the opposite direction. The semi-open inlet may for example also be a one-way valve. Preferably, the semi-open inlets allow air to pass through the inlet only if specific conditions are met, for example a minimum depression in the aerosol-generating device or a volume of air passing through the valve or membrane.

As used herein, the term ‘aerosol-forming substrate’ relates to a substrate capable of releasing one or more volatile compounds that can form an aerosol. Such volatile compounds may be released by heating the aerosol-forming substrate. The aerosol-forming substrate is preferably provided in liquid form in the liquid storage portion.

The aerosol-forming substrate is a substrate capable of releasing volatile compounds that can form an aerosol. The volatile compounds may be released by heating the aerosol-forming substrate. The aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. The aerosol-forming substrate may alternatively comprise a non-tobacco-containing material. The aerosol-forming substrate may comprise homogenised plant-based material.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Aerosol formers may be polyhydric alcohols or mixtures thereof, such as triethylene glycol, 1,3-butanediol and glycerine. The aerosol-former may be propylene glycol. The aerosol former may comprise both glycerine and propylene glycol.

The aerosol-forming substrate may be provided in liquid form. The liquid aerosol-forming substrate may comprise other additives and ingredients, such as flavourants. The liquid aerosol-forming substrate may comprise water, solvents, ethanol, plant extracts and natural or artificial flavours. The liquid aerosol-forming substrate may comprise nicotine. The liquid aerosol-forming substrate may have a nicotine concentration of between about 0.5% and about 10%, for example about 2%. The liquid aerosol-forming substrate may be contained in a liquid storage portion of the aerosol-generating article, in which case the aerosol-generating article may be denoted as a cartridge.

Preferably, the liquid aerosol-forming substrate is free of flavorant. The flavorant is preferably provided by the consumable. Particularly, the flavorant is preferably provided by the sensorial media of the consumable, while the liquid aerosol-forming substrate is merely provided to create an aerosol. Particularly preferred, the liquid aerosol-forming substrate is configured to create an aerosol and comprises nicotine. On the other hand, the consumable is preferably configured to provide flavor to the aerosol.

Operation of the aerosol-generating device may be triggered by a puff detection system. Alternatively, the aerosol-generating device may be triggered by pressing an on-off button, held for the duration of the user's puff. The puff detection system may be provided as a sensor, which may be configured as an airflow sensor to measure the airflow rate. The airflow rate is a parameter characterizing the amount of air that is drawn through the airflow channel of the aerosol-generating device per time by the user. The initiation of the puff may be detected by the airflow sensor when the airflow exceeds a predetermined threshold. Initiation may also be detected upon a user activating a button.

The sensor may be configured as a pressure sensor to measure the pressure of the air inside the aerosol-generating device which is drawn through the airflow channel of the device by the user during a puff. The sensor may be configured to measure a pressure difference or pressure drop between the pressure of ambient air outside of the aerosol-generating device and of the air which is drawn through the device by the user. The pressure of the air may be detected at the air inlet, a mouthpiece of the device, the cavity or any other passage or chamber within the aerosol-generating device, through which the air flows. When the user draws on the aerosol-generating device, a negative pressure or vacuum is generated inside the device, wherein the negative pressure may be detected by the pressure sensor. The term “negative pressure” is to be understood as a pressure which is relatively lower than the pressure of ambient air. In other words, when the user draws on the device, the air which is drawn through the device has a pressure which is lower than the pressure off ambient air outside of the device. The initiation of the puff may be detected by the pressure sensor if the pressure difference exceeds a predetermined threshold.

As used herein, the terms ‘upstream’, ‘downstream’, ‘proximal’ and ‘distal’ are used to describe the relative positions of components, or portions of components, of the aerosol-generating device in relation to the direction in which a user draws on the aerosol-generating device during use thereof.

The liquid storage portion may be any suitable shape and size. For example, the liquid storage portion may be substantially cylindrical. The cross-section of the liquid storage portion may, for example, be substantially circular, elliptical, square or rectangular.

The liquid storage portion may comprise a housing. The housing may comprise a base and one or more sidewalls extending from the base. The base and the one or more sidewalls may be integrally formed. The base and one or more sidewalls may be distinct elements that are attached or secured to each other. The housing may be a rigid housing. As used herein, the term ‘rigid housing’ is used to mean a housing that is self-supporting. The rigid housing of the liquid storage portion may provide mechanical support to the aerosol-generating means. The liquid storage portion may comprise one or more flexible walls. The flexible walls may be configured to adapt to the volume of the liquid aerosol-forming substrate stored in the liquid storage portion. The housing of the liquid storage portion may comprise any suitable material. The liquid storage portion may comprise substantially fluid impermeable material. The housing of the liquid storage portion may comprise a transparent or a translucent portion, such that liquid aerosol-forming substrate stored in the liquid storage portion may be visible to a user through the housing. The liquid storage portion may be configured such that aerosol-forming substrate stored in the liquid storage portion is protected from ambient air. The liquid storage portion may be configured such that aerosol-forming substrate stored in the liquid storage portion is protected from light. This may reduce the risk of degradation of the substrate and may maintain a high level of hygiene.

The liquid storage portion may be substantially sealed. The liquid storage portion may comprise one or more outlets for liquid aerosol-forming substrate stored in the liquid storage portion to flow from the liquid storage portion to the aerosol-generating device. The liquid storage portion may be arranged permanently in the main body of the aerosol-generating device. The liquid storage portion may be refillable. Alternatively, the liquid storage portion may be configured as a replaceable liquid storage portion. The liquid storage portion may be part of or configured as a replaceable cartridge. The aerosol-generating device may be configured for receiving the cartridge. A new cartridge may be attached to the aerosol-generating device when the initial cartridge is spent.

As used herein, an ‘aerosol-generating device’ relates to a device that interacts with an aerosol-forming substrate to generate an aerosol. The aerosol-forming substrate may be provided in liquid form in the liquid storage portion. An aerosol-generating device may be a smoking device that interacts with an aerosol-forming substrate to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

As used herein, the term ‘consumable’ refers to an article preferably comprising sensorial media that can provide flavor to the aerosol created in the aerosol-generating device. For example, a consumable may be a smoking article. The consumable may be disposable.

The consumable may be substantially cylindrical in shape. The consumable may be substantially elongate. The consumable may have a length and a circumference substantially perpendicular to the length. The consumable may be substantially rod shaped. The sensorial media may be substantially cylindrical in shape. Particularly preferred, the consumable as a hollow cylindrical shape. The hollow part of the cylindrical consumable forms the consumable airflow channel. The sensorial media may also have a hollow cylindrical shape preferably lining the inner wall of the tubular wall of the consumable. The length of the sensorial media is preferably identical to the length of the consumable. The length of the tubular wall is preferably identical to the length of the consumable.

In any of the aspects of the disclosure, the second heating element heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

As described, in any of the aspects of the disclosure, the second heating element heating element may be part of the aerosol-generating device. Alternatively, the second heating element may be provided as part of a cartridge comprising the liquid storage portion housing the liquid aerosol-forming substrate. The capillary material may in this case also be part of the cartridge.

The second heating element may take the form of one or more flexible heating foils on a dielectric substrate, such as polyimide. The flexible heating foils can be shaped to conform to the perimeter of the substrate receiving cavity. Alternatively, the second heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. Most preferred, however, the second heating element is configured as a helical resistive heating coil surrounding the capillary material. The second heating element may also be formed using a metal having a defined relationship between temperature and resistivity. In such an exemplary device, the metal may be formed as a track between two layers of suitable insulating materials. The second heating element formed in this manner may be used to both heat and monitor the temperature of the second heating element during operation.

The second heating element advantageously heats the liquid aerosol-forming substrate by means of conduction. The second heating element may be at least partially in contact with the liquid aerosol-forming substrate.

During operation, the liquid aerosol-forming substrate may be completely contained within the aerosol-generating device. In that case, a user may puff on a proximal end of the consumable. Alternatively, the aerosol-generating device may comprise a mouthpiece utilized by a user for inhalation of the generated aerosol. The consumable may in this case be covered by the mouthpiece.

The first heating element may be configured as an induction heating element. The induction heating element may comprise an induction coil and a susceptor. In general, a susceptor is a material that is capable of generating heat, when penetrated by an alternating magnetic field. When located in an alternating magnetic field. If the susceptor is conductive, then typically eddy currents are induced by the alternating magnetic field. If the susceptor is magnetic, then typically another effect that contributes to the heating is commonly referred to hysteresis losses. Hysteresis losses occur mainly due to the movement of the magnetic domain blocks within the susceptor, because the magnetic orientation of these will align with the magnetic induction field, which alternates. Another effect contributing to the hysteresis loss is when the magnetic domains will grow or shrink within the susceptor. Commonly all these changes in the susceptor that happen on a nano-scale or below are referred to as “hysteresis losses”, because they produce heat in the susceptor. Hence, if the susceptor is both magnetic and electrically conductive, both hysteresis losses and the generation of eddy currents will contribute to the heating of the susceptor. If the susceptor is magnetic, but not conductive, then hysteresis losses will be the only means by which the susceptor will heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate.

The susceptor may be formed from any material that can be inductively heated to a temperature sufficient to generate an aerosol from the aerosol-forming substrate. A preferred susceptor may comprise or consist of a ferromagnetic material or ferri-magnetic material, for example a ferromagnetic alloy, ferritic iron, or a ferromagnetic steel or stainless steel. A suitable susceptor may be, or comprise, aluminium. Preferred susceptors may be heated to a temperature in excess of 250 degrees Celsius.

Preferred susceptors are metal susceptors, for example stainless steel. However, susceptor materials may also comprise or be made of graphite, molybdenum, silicon carbide, aluminum, niobium, Inconel alloys (austenite nickel-chromium-based superalloys), metallized films, ceramics such as for example zirconia, transition metals such as for example iron, cobalt, nickel, or metalloids components such as for example boron, carbon, silicon, phosphorus, aluminium.

The first induction heating element may be arranged at least partly, preferably fully, surrounding the distal portion of the cavity. The susceptor element is preferably configured as a cylindrical susceptor at least partly surrounding the cavity or forming the sidewall of the cavity.

Features described in relation to one embodiment may equally be applied to other embodiments of the invention.

The invention will be further described, by way of example only, with reference to the accompanying drawings in which:

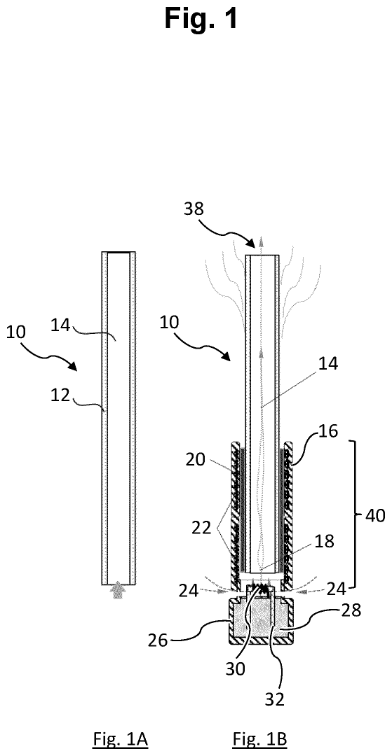

FIGS. 1A and 1B show an aerosol-generating system comprising an aerosol-generating device and a consumable;

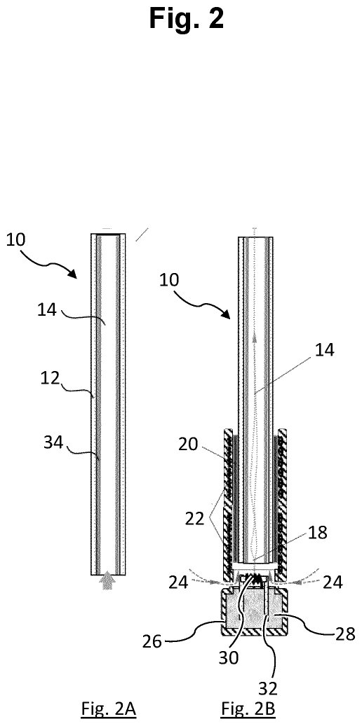

FIGS. 2A and 2B show an aerosol-generating system comprising an aerosol-generating device and a consumable comprising sensorial media; and

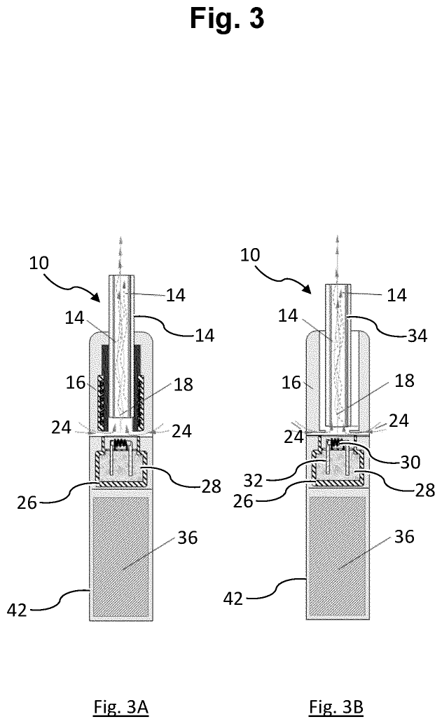

FIGS. 3A and 3B show an aerosol-generating system comprising an aerosol-generating device and a consumable, wherein the device comprises a power supply;

FIGS. 1A and 1B show an aerosol-generating system comprising an aerosol-generating device 16 and a consumable 10. The consumable 10 is shown in FIG. 1A before being inserted into a cavity 18 of the aerosol-generating device 16.

The consumable 10 comprises a tubular wall 12 and a consumable airflow channel 14. Further (not shown), the consumable 10 may be provided with a paper tipping paper as an outer wrapper.

The tubular wall 12 extends over the full length of the consumable 10. The tubular wall 12 has a hollow cylindrical shape. tubular wall 12 crates the dimensional stability of the consumable 10. Air can flow through the tubular wall 12. The tubular wall 12 creates the consumable airflow channel 14. The consumable airflow channel 14 is arranged to run centrally through the consumable 10. The tubular wall 12 is preferably porous such that at least flavor being drawn can permeate through the tubular wall 12 to a degree. This is illustrated in FIG. 1B near a proximal end 38 of the consumable 10.

In the embodiment of FIG. 1, the consumable 10 does not comprise any other components.

FIG. 1B shown that the consumable 10 is received in the cavity 18 of the aerosol-generating device 16. The aerosol-generating device 16 comprises a first heating element to heat a distal portion 40 of the consumable 10. The first heating element comprises a susceptor 20 and induction coils 22.

In the embodiment shown in FIG. 1B, two induction coils 22 are shown. The two induction coils 22 can heat different portions of the susceptor 20 via induction heating. This may lead to the provision of two heating zones in the cavity 18 such that the distal portion 40 of the consumable 10 is received in these two heating zones. Depending upon the requirements of the aerosol generation, the first heating element may be controlled to heat one of the heating zones to a different temperature then the other heating zone. Alternatively, only a single induction coil may be provided to heat the susceptor 20 to a uniform temperature.

FIG. 1B further shows an air inlet 24 upstream of the cavity 18. The air inlet 24 is arranged to enable ambient air to be drawn laterally into the aerosol-generating device 16.

FIG. 1B further shows a liquid storage portion 26 of the aerosol-generating device 16. The liquid storage portion 26 can be refillable or be part of a replaceable cartridge. Liquid aerosol-forming substrate 28 is held in the liquid storage portion 26. A second heating element is also shown in FIG. 1B. The second heating element is configured as a resistive heating coil 30. The heating coil 30 is wound around capillary material 32. The capillary material 32 contacts the liquid aerosol-forming substrate 28 held in the liquid storage portion 26 and wicks the liquid aerosol-forming substrate 28 towards the heating coil 30.

During operation, ambient air is drawn into the aerosol-generating device 16 through the air inlet 24. Centrally in the aerosol-generating device 16, the heating coil 30 is arranged and the ambient air is drawn past the heating coil 30. The heating coil 30 vaporized the liquid aerosol-forming substrate 28 wicked to the heating coil 30 via the capillary material 32. The vaporized liquid aerosol-forming substrate 28 is entrained in the airflow and drawn towards the cavity 18.

The air is further drawn into the cavity 18 and into the central consumable airflow channel 14. In the consumable airflow channel 14, the air and the vaporized aerosol-forming substrate can cool down to form an inhalable aerosol. If the liquid aerosol-forming substrate 28 contains a flavorant, the flavor may at least partly permeate through a proximal portion of the consumable 10 to create a pleasant smell for the user.

FIGS. 2A and 2B show a different embodiment. All elements of this embodiment are the same as the elements described with respect to FIGS. 1A and 1B. The only difference is that sensorial media 34 is provided on the inner surface of the tubular wall 12 of the consumable 10. The sensorial media 34 is coated onto the inner surface of the tubular wall 12. The sensorial media 34 comprises a flavorant. The liquid aerosol-forming substrate 28 held in the liquid storage portion 26 is in this embodiment preferably free of a flavorant, since the flavor of the generated aerosol can be modified by the used consumable 10. The flavor of the sensorial media 34 my, at least predominantly, be released by heating of the sensorial media 34 via the first heating element. Alternatively or in addition, the flavor of the sensorial media 34 may be released at ambient temperatures.

FIGS. 3A and 3B show further detailed and alternatives of the aerosol-generating device 16. In FIG. 3A, the aerosol-generating device 16 of FIGS. 1B and 2B is shown. The aerosol-generating device 16 further comprises a main body 42 with a power supply 36 in the form of a battery.

In FIG. 3B, a version of the aerosol-generating device 16 is shown in which the first heating element is omitted. The consumable 10 in this embodiment is provided with sensorial media 34 which releases the contained flavorant at ambient temperatures or at slightly higher temperatures provided by the hot air being drawn into the consumable airflow channel 14 and being heated by the heating coil 30.

1. An aerosol-generating system comprising an aerosol-generating device and a consumable for the aerosol-generating device, wherein the aerosol-generating device comprises:
a cavity for receiving the consumable,
a first heating element arranged to at least partly heat the consumable when the consumable is received in the cavity, and
an airflow channel, wherein the airflow channel is arranged to direct air through the device and into the cavity,
wherein the consumable comprises:
a tubular wall, wherein the tubular wall extends from a distal opening of the consumable to an opposite proximal opening of the consumable, wherein the tubular wall has a thickness of between 3 mm and 7 mm, wherein the consumable comprises a layer of sensorial media on one or both of the inner surface of the tubular wall and the outer surface of the tubular wall,
wherein the consumable is arranged, when the consumable is received in the cavity, such that the air flowing into the cavity from the airflow channel flows into the distal opening of the consumable.

2. The aerosol-generating system according to claim 1, wherein the aerosol-generating device further comprises a liquid storage portion containing liquid aerosol-forming substrate.

3. The aerosol-generating system according to claim 2, wherein the aerosol-generating device further comprises a second heating element configured to volatilize the liquid aerosol-forming substrate.

4. The aerosol-generating system according to claim 3, wherein the second heating element is arranged to volatilize the liquid aerosol-forming substrate upstream of the cavity.

5. The aerosol-generating system according to claim 4, wherein the aerosol-generating device further comprises an air inlet, wherein the air inlet is arranged distal from the cavity and proximal from the liquid storage portion.

6. The aerosol-generating system according to claim 3, wherein the second heating element is a resistive heating element, preferably wherein the second heating element is a heating coil arranged at least partly surrounding a wick, wherein the wick extends into the liquid storage portion for wicking the liquid aerosol-forming substrate towards the heating coil.

7. The aerosol-generating system according to claim 6, wherein the aerosol-generating device further comprises a wick extending into the liquid storage portion, and wherein the second heating element is a heating coil arranged around the wick.

8. The aerosol-generating system according to claim 1, wherein the first heating element is an inductive heating element.

9. The aerosol-generating system according to claim 8, wherein the first heating element comprises an induction coil and a tubular susceptor, wherein the tubular susceptor is arranged surrounding a distal portion of the cavity.

10. The aerosol-generating system according to claim 1, wherein the sensorial media is a flavourant that is coated onto or applied to or impregnated into one or both of the inner surface of the tubular wall and the outer surface of the tubular wall.

11. The aerosol-generating system according to claim 1, wherein the consumable comprises a tipping paper surrounding the tubular wall.

12. The aerosol-generating system according to claim 1, wherein the consumable consists of the tubular wall and a layer of sensorial media on the inner surface of the tubular wall or wherein the consumable consists of the tubular wall and a layer of sensorial media on the inner surface of the tubular wall and a tipping paper surrounding the tubular wall.

13. The aerosol-generating system according to claim 1, wherein the consumable is free of tobacco.

14. The aerosol-generating system according to claim 1, wherein the cavity is dimensioned to receive the consumable of any of claims 10 to 14 or a consumable comprising tobacco having a larger diameter.
